(19) United States
(12) Patent Application Publication
(10) Pub. No.: US 2007/0272160 A1
(43) Pub. Date: Nov. 29, 2007

(54) Modified milk-collecting component

(76) Inventors: Michael Berentzen, Soest (DE); Anne Schulze Schwering, Munster (DE); Martin Neumann, Oelde (DE)

Correspondence Address: SMITH LAW OFFICE, 440 SCIENCE DR., SUITE 302, MADISON, WI, 53711, US

(21) Appl. No.: 11/801,689

(22) Filed: May 10, 2007

Related U.S. Application Data
(60) Provisional application No. 60/799,421, filed on May 10, 2006.

(51) Int. Cl. A01J 5/00

(52) U.S. Cl. 119/14.54

(57) ABSTRACT

A milk-collecting component for receiving milk from an animal, the component having inflow connectors and a bottom housing with an outflow connector. The inflow connectors being spaced or angled to accommodate an animal's anatomy. The bottom housing part having a milk directing surface to enhance flow through the milk-collecting component or reduce foaming of the milk.

This application claims priority on Provisional Application No. 60/799,421 filed May 10, 2006.

### BACKGROUND OF THE INVENTION

The invention relates to a milk-collecting component and to a teat-cup cluster for milking an animal, in particular a cow.

### SUMMARY OF THE INVENTION

Milk-collecting components for a milking installation are known. They serve for intercepting the milk coming from the teat cups, via a short milk hose, and for passing this milk on, via a long milk hose and possibly a milk pipe, to a milk-collecting vessel, in particular a milk tank.

A milk-collecting component comprises a top housing part which has four inflow connectors. Short milk hoses, at the ends of which a respective teat cup is arranged, can be connected to the inflow connectors. A bottom housing part is connected to the top housing part. The bottom housing part has a milk-outflow connector. Such a configuration of a milk-collecting component is known, for example, from Utility Model G 94 05 916.

Taking this as a departure point, it is an object of the present invention to develop the milk-collecting component of the generic type so as to improve a milking operation yet further.

The milk-collecting component according to the invention comprises a top housing part with four inflow connectors and a bottom housing part with a milk-outflow connector. In each case two inflow connectors are arranged differently in relation to the top housing part. In the case of a preferred configuration of the milk-collecting component, the latter has in each case two pairs of inflow connectors, each pair having in each case two inflow connectors. The inflow connectors of the respective pair are preferably arranged in the same way in relation to the top housing part. However, the pairs are arranged differently as far as their set-up in relation to the top housing part is concerned.

This configuration of the milk-collecting component according to the invention makes it possible for the teat-cup cluster to be better adapted to the udder/teat geometry. It is thus possible, for example, for a spacing between the inlet openings of the inflow connectors of one pair to differ from the spacing between the inlet openings of the inflow connectors of the other pair, in which case the one pair is used for connecting to teat cups which are fitted, for example, onto the front teats of the animal, while the other pair of inflow connectors is used for connecting to teat cups which are fitted onto the rear teats of the animal. This means that the teat cups do not rub against one another if the teats of the animal are positioned closely together and it is also the case that no leakage air passes into the teat-cup cluster, this being associated with fluctuations in the vacuum within the milking installation. A further advantage of this configuration may also be considered to be the fact that the teats are subjected to uniform loading. Furthermore, better milking-out behavior is achieved.

According to a further advantageous configuration of the milk-collecting component, it is proposed that the inflow connectors project obliquely upward from the top housing part, the angles of in each case two inflow connectors being equal. This results in even better adaptation to the teat geometry of an animal.

The milk which is obtained by milking passes into the interior of the milk-collecting component. In order to improve the outflow of milk from the milk-collecting component, it is proposed that the bottom housing part has at least one directing surface. The directing surface is preferably an integral constituent part of a wall of the bottom housing part. The directing surface also serves for reducing the foaming of the milk.

According to yet another configuration of the milk-collecting component according to the invention, it is proposed that the inner cross section of the bottom housing part decreases in the direction of the milk-outflow connector. A preferred configuration here is one in which the inner cross section of the housing part decreases in a funnel-like manner in the direction of the milk-outflow connector.

According to yet another advantageous configuration of the milk-collecting component, it is proposed that the bottom housing part contains at least one valve body by means of which the milk-outflow connector can be closed at least in part.

According to yet another proposal, the top housing part can be connected to the bottom housing part in at least two different predetermined positions. This makes the milk-collecting component more versatile to use, while keeping the number of components required small.

According to yet another inventive idea, a teat-cup cluster for milking an animal, in particular a cow, having a milk-collecting component which has a top housing part with four inflow connectors and a bottom housing part with a milk-outflow connector is proposed, teat cups which are connected to the inflow connectors by means of short milk hoses being provided.

A preferred configuration of a teat-cup cluster here is one in which at least two different teat cups are provided. This achieves yet a further improvement in the adaptation of the teat-cup cluster to the teats and/or udder geometry.

A particularly preferred configuration of the teat-cup cluster here is one in which the teat cups differ in respect of their weight.

In view of the number of different shapes and sizes of teats and udders, it is proposed that the teat cups differ in respect of at least one geometrical parameter of the teat rubber. It is not imperative here for the teat-cup sheaths to differ. They may be different, but this is not necessary. It is sufficient for the teat rubbers to have different geometries. It is possible here for the teat rubbers to differ, for example, in respect of the opening in the head region. They may also be of different lengths.

According to yet another advantageous configuration of the teat-cup cluster, it is proposed that the teat cups differ in respect of a parameter, preferably a mechanical parameter, of the teat rubber. It is possible for the teat rubbers to consist of different materials which have different hardnesses, in which case their fold-in behaviors differ.

Further advantages and details of the invention are explained with reference to the exemplary embodiment illustrated in the drawing, although the subject matter of the invention is not limited to this specific exemplary embodiment. In the drawing:

### BRIEF DESCRIPTION OF THE DRAWINGS

FIG. 1 shows a plan view of a milk-collecting component, and

FIG. 2 shows the milk-collecting component in cross section.

### DESCRIPTION OF THE PREFERRED EMBODIMENTS

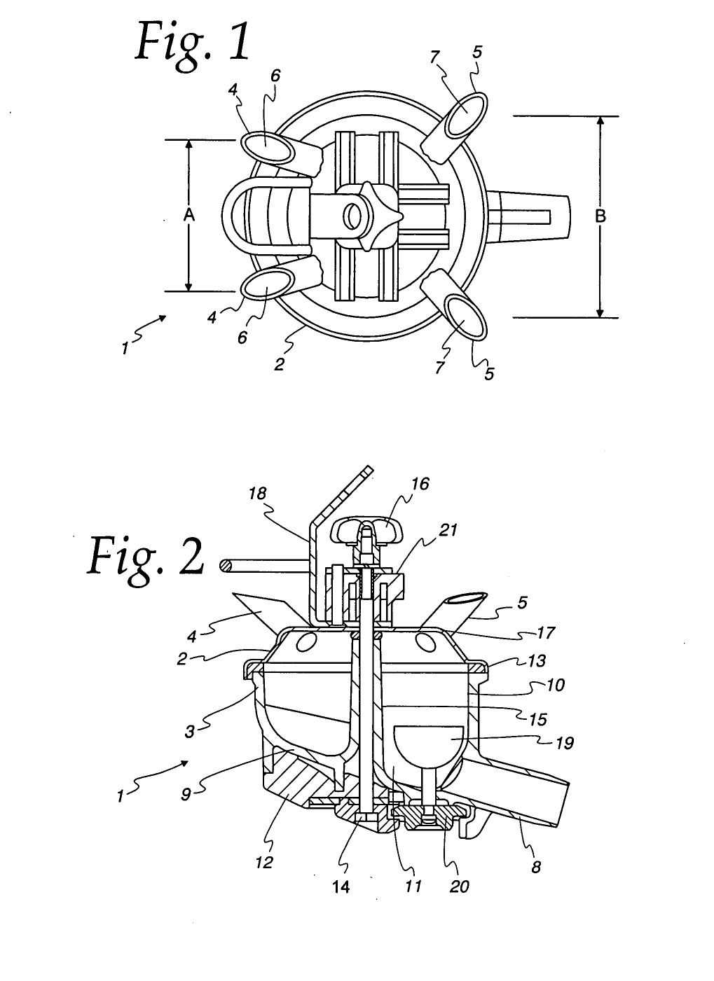

FIGS. 1 and 2 illustrate a milk-collecting component 1. The milk-collecting component has a top housing part 2 and a bottom housing part 3. Four inflow connectors 4, 5 are connected to the top housing part 2. It can be seen from the illustration in FIG. 1 that in each case two inflow connectors 4 and 5 are arranged differently in relation to the top housing part 2. The inflow connectors have inlet openings 6, 7. The spacing between the inlet openings 6 of the inflow connectors 4 is designated by A. The spacing between the inlet openings 7 of the inflow connectors 5 is designated by B. The illustration shows that the spacing A is smaller than the spacing B. The inflow connectors 4 serve for connecting the milk-collecting component 1 to teat cups which are fitted onto the rear teats of the animal which is to be milked. The teat cups which are fitted onto the front teats are connected to the milk-collecting component by the inflow connectors 5. The teat cups (not illustrated) are connected via corresponding short milk hoses.

The inflow connectors 4 form one pair, while the inflow connectors 5 form a further pair. The inflow connectors of the respective pair are designed in the same way. The inflow connectors of different pairs are designed differently, as can be seen from FIG. 1. It is also possible here for the angles at which the inflow connectors 4, 5 are directed obliquely downward onto the top housing part 2 to differ.

The bottom housing part 3 has a milk-outflow connector 8. The milk-outflow connector 8 is inclined in relation to a horizontal, in which case milk can flow out of the bottom housing part 3. In order to improve the outflow of the milk, the bottom housing part 3 has a housing base 9 which is inclined in the direction of the milk-outflow connector 8. The wall 10 of the bottom housing part 3 is preferably at least partially rotationally symmetrical, the wall containing preferably two directing surfaces 11 which are formed opposite one another, reduce the vortexing of the milk flowing into the milk-collecting component 1 via the inflow connectors 4, 5 and help the milk to flow out via the milk-outflow connector 8.

An elastic element 12 is provided on the underside of the housing base 9. The elastic element has a damping effect when the milk-collecting component falls, by way of its underside, onto an object or an underlying surface. Furthermore, the shape or form of the elastic element 12 aids handling.

A seal 13 is provided between the top housing part 2 and the bottom housing part 3. The top housing part is connected to the bottom housing part by means of a screw connection. A screw 14, which extends through a receiving means 15, is provided for this purpose. The screw is connected to a screw-action knob 16. The screw-action knob 16 acts on the top housing part 2 indirectly via an air-distributing component 21. A seal 17 is provided between the end surface of the receiving means 15 and the top housing part 2. The screw-action knob 16 also secures an air-distributing component 21 and a mount 18, with a removal eyelet, on the milk-collecting component 1.

A valve body 19 is arranged within the milk-collecting component 1, in front of the milk-outflow connector 8. The valve body 19 is connected to an operating part 20 which can alter the position of the valve body 19 within the milk-collecting component 1.

1. A milk-collecting component comprising a top housing part with four inflow connectors and a bottom housing part with a milk-outflow connector, wherein in two inflow connectors are arranged differently in relation to the top housing part.

2. The milk-collecting component as claimed in claim 1, wherein the inflow connectors each have an inlet opening, the respective spacings between two inlet openings being equal.

3. The milk-collecting component as claimed in claim 1, wherein the inflow connectors project obliquely upward from the top housing part, the angles of two inflow connectors being equal.

4. The milk-collecting component as claimed in claim 1, wherein case two inflow connectors form a respective inflow-connector pair, the inflow connectors within an inflow-connector pair being arranged in the same way, but the pairs differing in respect of the arrangement of the inflow connectors, and wherein one inflow-connector pair is suitable, and intended, for connecting to a respective teat cup which is fitted on the front teats and the other inflow-connector pair is suitable, and intended, for connecting to a respective teat cup which is fitted on the rear teats.

5. The milk-collecting component as claimed in at least one of preceding claim 1, wherein the bottom housing part has at least one directing surface.

6. The milk-collecting component as claimed in claim 5, wherein the at least one directing surface is an integral constituent part of a wall of the bottom housing part.

7. The milk-collecting component as claimed in claim 5, wherein the inner cross section of the bottom housing part decreases in the direction of the milk-outflow connector, in particular decreases in a funnel-like manner.

8. The milk-collecting component as claimed in at least one of preceding claim 1, wherein the bottom housing part contains at least one valve body by means of which the milk-outflow connector can be closed at least in part.

9. The milk-collecting component as claimed in at least one of preceding claim 1, wherein the top housing part can be connected to the bottom housing part in at least two different, predetermined positions.

10. A teat-cup cluster for milking an animal having a milk-collecting component which has a top housing part with four inflow connectors and a bottom housing part with a milk-outflow connector, and having teat cups which are connected to the inflow connectors by means of short milk hoses, the milk-collecting component comprising a top housing part with four inflow connectors and a bottom housing part with a milk-outflow connector, wherein in each case two inflow connectors are arranged differently in relation to the top housing part.

11. The teat-cup cluster as claimed in claim 10, wherein at least two different teat cups are provided.

12. The teat-cup cluster as claimed in claim 11, wherein the teat cups differ in respect of their weight.

13. The teat-cup cluster as claimed in claim 11, wherein the teat cups differ in respect of at least one geometrical parameter of the teat rubber.

14. The teat-cup cluster as claimed in claim 11, wherein the teat cups differ in respect of at least one mechanical parameter of the teat rubber.
